(19) United States
(12) Patent Application Publication
(10) Pub. No.: US 2006/0289568 A1
(43) Pub. Date: Dec. 28, 2006

(54) Collapsible tube for containing and dispensing paste

(76) Inventor: Gaston Schang, Ciudad Autonoma de Buenos Aires (AR)

Correspondence Address: BRACEWELL & GIULIANI LLP, P.O. BOX 61389, HOUSTON, TX, 77208-1389, US

(21) Appl. No.: 11/327,293

(22) Filed: Jan. 6, 2006

(30) Foreign Application Priority Data
Jun. 22, 2005 (AR) P 05 010 2568

(51) Int. Cl. G01F 11/00; B65D 35/00

(52) U.S. Cl. 222/386; 222/107

(57) ABSTRACT

A collapsible paste tube for containing and dispensing paste, the tube having a rearward closed end and a forward open end for supplying the paste, and a plunge member freely arranged within the tube, with the paste being packaged between the plunger member and the open end of the tube.

### BACKGROUND OF THE INVENTION

1. Field of the Invention

The present invention relates to a new container for paste products and more particularly a new collapsible container, such as a tube, for containing and easily dispensing semi-solid substances such as toothpaste.

2. Description of the Prior Art

The semi-solid substances, like toothpaste, have been packaged in collapsible containers such as the well know tubes that make possible to dispense the paste out of the tube by manually pressing the tube in order to expel the contained paste. The tubes have been made from a variety of materials such as metal and plastics, however, in all the cases the paste can not be entirely squeezed out of the tube and an important part of the paste remains within the container which is disposed with this part of the paste therein.

Many dispensing devices have been developed with the purpose of squeezing all the paste out of the tube, which devices are generally complex and costly as well as they are no practical for use.

U.S. Pat. No. 4,565,303 to Gilberston discloses a device for dispensing paste from a squeeze-type tube wherein the device comprises a stationary member and a movable member both members connected to each other in a hinged manner in order to place the tube with paste between the two members and move the movable member against the stationary member to collapse the tube progressively from the rearward end to the forward end thereof so as to expel the paste out from the tube.

U.S. Pat. No. 5,105,984 to Kazimir discloses a dispenser for extruding paste from a tube wherein the dispenser comprises a support portion hinged to a cover portion with the paste tube being placed between both portions such that when the cover portion is pressed the paste is extruded from the tube. The hinge is adjustable and the support and cover portions have respective resilient liners for providing a spring rate and for snugly holding the tube.

While some of the well know devices have worked well the same are costly and cumbersome, designed for example for fixing in a wall or any part of a forniture and the paste tube needs to be installed into the device, however there are no devices or dispenser that are simple and directly provided in the paste tube in order to make the squeezing out of the paste easy and simple without the need of any system out of the tube. In other words, it would be convenient to have a paste tube provided with its own dispenser system incorporated therein.

### SUMMARY OF THE INVENTION

It is therefore an object of the invention to provide a new paste tube containing a paste, like a toothpaste, and a paste delivering means located with the tube and capable of being operated manually by squeezing the tube as conventionally done.

It is still another object of the present invention to provide a collapsible paste tube for containing and dispensing paste, the tube having a rearward closed end and a forward open end for supplying the paste, and a plunge member freely arranged within the tube, with the paste being packaged between the plunger member and the forward end of the tube.

It is a further object of the present invention to provide a container for containing and dispensing paste, the container comprising a collapsible tube having a rearward closed end and a forward open and closable end for supplying the paste, and at least one paste delivering means freely placed into the tube and having a periphery sealing against an inner surface of the tube, whereby when the paste tube is squeezed behind the delivery means this means moves towards the forward open end of the tube and the paste is forced out of the tube through the open forward end thereof.

The above and other objects, features and advantages of this invention will be better understood when taken in connection with the accompanying drawings and description.

### BRIEF DESCRIPTION OF THE DRAWINGS

The present invention is illustrated by way of example in the following drawings wherein:

FIG. 1 shows a cross sectional view of a paste tube with paste dispensing means according to the present invention, with the tube being full of paste and the dispensing means being at a starting position;

FIG. 2 shows a cross sectional view of the tube of FIG. 1 with the dispensing means at a middle position along the paste tube;

FIG. 3 shows a cross sectional view of the tube of FIGS. 1 and 2 with the dispensing means being close to the open end of the tube and the paste almost entirely squeezed out of the tube;

FIG. 4 is a perspective view of a paste dispensing means according to another embodiment of the invention;

FIG. 5 is a cross sectional view of the dispensing means of FIG. 4, taken along line V-V, and

FIG. 6 is a cross sectional view of the dispensing means of FIG. 4, taken along line VI-VI.

### DESCRIPTION OF THE PREFERRED EMBODIMENTS

Now referring in detail to the invention, the same refers to container for containing and dispensing paste, more preferably the container is of the type comprising a collapsible tube 1, made of any suitable material such as aluminium, other malleable metals, plastics and the like. Tube 1 has a rearward closed end 2 that may be closed by any known technique along a seal 3 by a crimp seal, if the tube is of metal, or a heat welding seal, if the tube is of plastics. The tube has also a forward open end 4 having a neck portion 5, generally of a conical shape, and a cap 6 that can be threaded onto neck 5 for closing an opening therein. The cap, as it is well known, may be removed to have the opening clear for supplying the paste when desired.

According to the invention, tube 1 is provided with at least one paste delivering means 7 that is freely placed into the tube and has a periphery 8 sealing against an inner surface 9 of tube 1, whereby the paste, indicated by reference number 10, is contained between end 4 of the tube and delivering means 7. Since delivering means 7 is designed to perfectly, or at least almost perfectly, seal against the inner surface of the wall of tube 1, it may be seen that almost all the paste is restricted to remain contained between means 7 and the forward end of the tube without any substantial part of the paste passing towards the rearward potion of the tube.

In view of the particulars of the dispensing means of the invention, when the paste tube is squeezed by hand, particularly by pressing behind or onto the portion of the tube where delivery means 7 is located this means moves towards forward open end 4 of the tube and the paste is forced out of the tube through the open forward end thereof.

According to a preferred embodiment of the invention paste delivering means 7 comprises one piece freely arranged within the tube. In other words, means 7 has no connection to any outer member but it only remains free within the tube in order to move forward upon the action of the fingers of the user when squeezing the tube at a portion behind means 7 or onto means 7 in direction towards forward end 4. Since a seal is formed between means 7 and tube 1 at the periphery 8 no paste is permitted to pass rearward of means 7 and, therefore, the rearward portion of the tube will remain almost entirely free of paste as illustrated by reference 11.

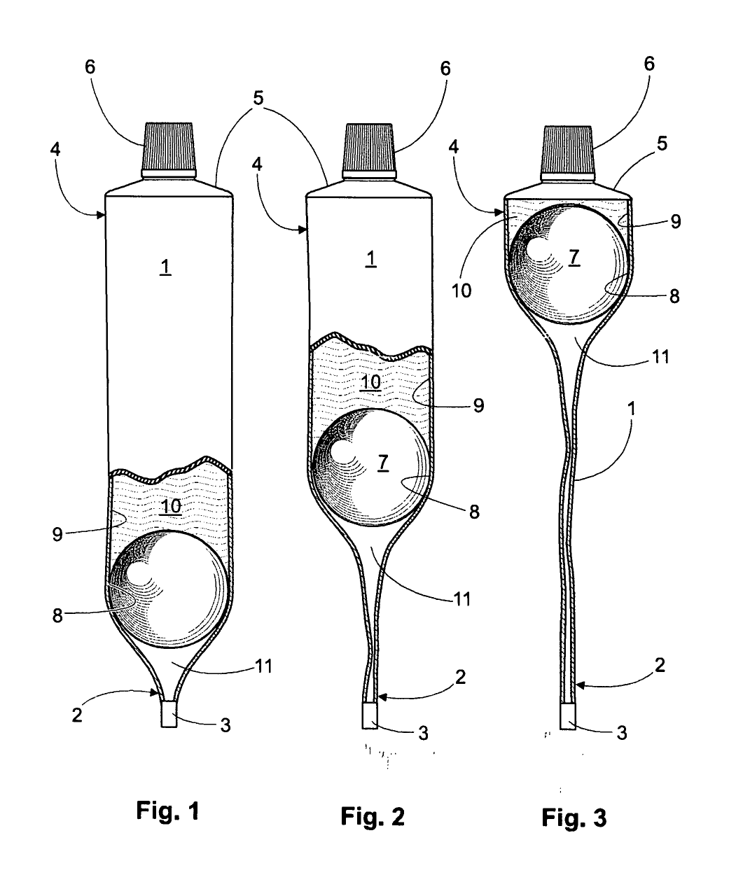

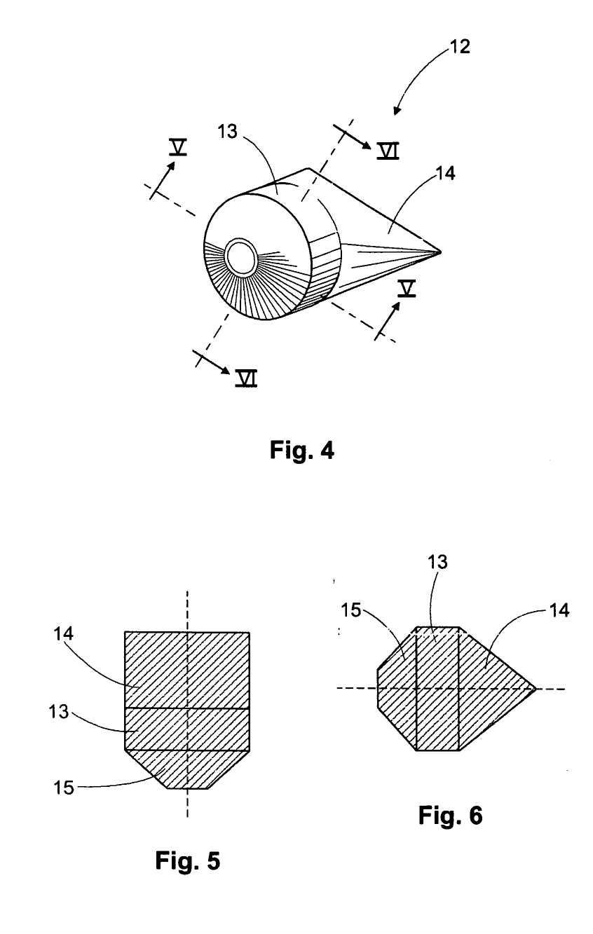

Preferably, the dispensing means comprises a spherical pioece, as shown in FIGS. 1-3, however dispensing means 7 may comprise other appropriate forms and shapes such as the one shown in FIGS. 4-6. According to this alternative embodiment, dispensing means comprises a piece 12 having at least a partial cylinder shape. More particularly, piece 12 has a forward cylindrical portion 13 and a rearward conical portion 14 accommodated to the shape that usually has the conventional tube rearward ends. In addition, cylindrical portion 13 may have also a conical leading shape 15 that accommodates to neck portion 5 of tube 1.

Also within the alternatives of the invention, the paste delivering piece may be a solid piece or a hollow piece as well as it may include an item such as a prize, a gift or a voucher for a prize. In addition, paste dispensing piece may be made of a transparent plastic and it may be a promotion article or an advertising article.

While preferred embodiments of the present invention have been illustrated and described, it will be obvious to those skilled in the art that various changes and modifications may be made therein without departing from the scope of the invention as defined in the appended claims.

I claim:

1. A container for dispensing paste, the container comprising:
a collapsible tube having a rearward closed end and a forward open and closable end for supplying the paste, and
at least one paste delivering means freely placed into the tube and having a periphery sealing against an inner surface of the tube, whereby when the paste delivery means moves towards the forward open end of the tube the paste is forced out of the tube through the open forward end thereof.

2. The container of claim 1, wherein the paste delivering means comprises one piece freely arranged within the tube.

3. The container of claim 2, wherein the piece is a sphere.

4. The container of claim 2, wherein the piece has at least a partial cylinder shape.

5. The container of claim 4, wherein the piece has a forward cylindrical portion and a rearward conical portion accommodated to a tube rearward end shape.

6. The container of claim 2, wherein the piece is a solid piece.

7. The container of claim 2, wherein the piece comprises a hollow piece.

8. The container of claim 7, wherein the hollow piece includes an item.

9. The container of claim 8, wherein the item is a prize.

10. The container of claim 8, wherein the item is a gift.

11. The container of claim 8, wherein the item is a voucher for a prize.

12. The container of claim 2, wherein the piece is a plastic transparent piece.

13. The container of claim 2, wherein the piece is a promotion article.

14. The container of claim 2, wherein the piece is an advertising article.
